(19) United States
(12) Patent Application Publication
(10) Pub. No.: US 2008/0168352 A1
(43) Pub. Date: Jul. 10, 2008

(54) System and Method for Displaying Related Entity Information

(75) Inventors: Shishir Mehrotra, Seattle, WA (US); Roger A. Lueder, Redmond, WA (US); Steve De Mar, Redmond, WA (US); Alex DeNeui, Seattle, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 11/620,396

(22) Filed: Jan. 5, 2007

(51) Int. Cl. G06F 3/00

(52) U.S. Cl. 715/713

(57) ABSTRACT

When displaying various types of information, an application may identify whether any related entities exist. For example, when displaying an e-mail message, the sender information may relate to a contact entity. As such, information associated with the contact entity may be displayed along with the message. The related entity data (e.g., contact entity data) may be displayed in a subregion of the display area corresponding to the parent entity data (e.g., an e-mail message information) and/or differentiated in various manners. An application interface may further be configurable to control an amount of related entity data that is displayed. A property picker system may also be used to allow a user to specify the properties that he or she wants to make available for display in the interface.

### BACKGROUND

In many applications, information displayed in those applications often includes references to other types of information. For example, e-mail applications display e-mail messages along with various properties such as sender information, recipient information, subject and date received. In one or more instances, the properties may relate to an information type that includes additional properties. In the e-mail example, the sender information may relate to a particular contact stored on the user's system. As such, additional contact information beyond what is provided in the e-mail itself may be available for a user's perusal. However, current application interfaces do not enable a user to view such related property information simultaneously. In other words, current e-mail applications, for example, do not display an e-mail message along with information about the sender in the same interface. Instead, many applications require the user to select the sender to view contact information in a separate interface or screen. Furthermore, applications often only draw from their own data stores to determine what is displayed in the interface. This prevents other or additional pertinent information from being displayed in the application.

### SUMMARY

Systems and methods for displaying entity (i.e., information types) data along with related entity data is provided to give users additional context and information when viewing a particular type of information, e.g., e-mails or images. Information types may be defined as entity types by a data model that further characterizes various attributes of an information type as properties of the entity or information type. In one or more instances, properties of an entity may relate to another entity or entity type. In the case of images, an image entity may include a property listing people depicted in the image. As such, the people property of the image entity may relate to one or more contact entities corresponding to the people listed. When browsing such image entities, the contact information associated with the people depicted in the images may then be displayed with the image entity. In one or more arrangements, related entity data (e.g., contact information) may be displayed in a subregion of the display area occupied by the primary entity data (e.g., message information). If multiple related entities exist for a particular entity, those related entities may be displayed in a list within the subregion. The related entity data may be differentiated from the primary entity data using a variety of methods and systems including the use of different fonts and colors.

According to another aspect, an interface displaying both entity data and related entity data may be configurable. A user may modify the interface such that more or less related entity data is displayed with the entity data. For example, if a user does not want to view company information or title information of a contact that sent an e-mail message, the user may modify the related entity data subregion to show only a name of the contact. Likewise, if the user wishes to view additional information about a related entity, the user may toggle the interface to display more related entity data, if available.

According to yet another aspect, a property picker interface may be provided to allow a user to specify which properties of an entity or related entity to display in an interface. In one example, a property picker interface for an e-mail message entity type may display a list of properties including from, to, cc, bcc and the like. Each property may then list one or more subproperties belonging to a related entity type associated with that property. For example, a from property may relate to a particular contact entity. The properties of a contact entity may thus be displayed in the property picker to allow a user to select which properties of a related contact entity should be made available for display.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Aspects of the invention are illustrated by way of example and not limited in the accompanying figures in which like reference numerals indicate similar elements and in which:

FIG. 1 illustrates a schematic diagram of a general-purpose digital computing environment in which one or more aspects described herein may be implemented.

FIG. 2 illustrates a display showing a messaging application interface according to one or more aspects described herein.

FIG. 3 illustrates a property picker interface for controlling the amount and type of properties that are displayed in an application interface according to one or more aspects described herein.

FIG. 4 is a flowchart illustrating a method for displaying an application interface according to one or more aspects described herein.

FIG. 5 is a flowchart illustrating a method for manipulating and configuring an application interface according to one or more aspects described herein.

### DETAILED DESCRIPTION

In the following description, reference is made to the accompanying drawings, which form a part hereof, and in which is shown by way of illustration various embodiments. It is to be understood that other embodiments may be utilized and structural and functional modifications may be made without departing from the scope of the present disclosure.

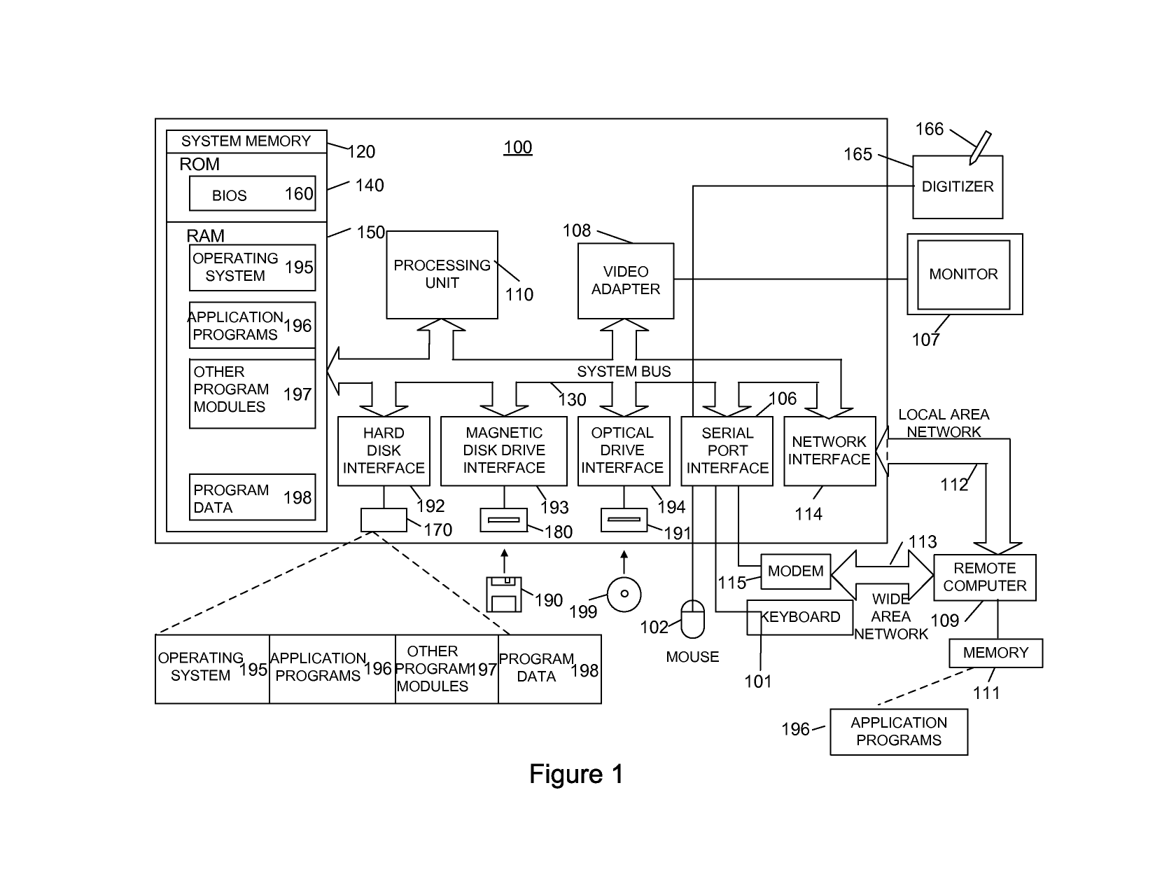

FIG. 1 illustrates a schematic diagram of a general-purpose digital computing environment. In FIG. 1, a computer 100 includes a processing unit 110, a system memory 120, and a system bus 130 that couples various system components including the system memory 120 to the processing unit 1 10. The system bus 130 may be any of several types of bus structures including a memory bus or memory controller, a peripheral bus, and a local bus using any of a variety of bus architectures. The system memory 120 may include read only memory (ROM) 140 and random access memory (RAM) 150.

A basic input/output system 160 (BIOS), which contains the basic routines that help to transfer information between elements within the computer 100, is stored in the ROM 140. The computer 100 also may include a hard disk drive 170 for reading from and writing to a hard disk (not shown), a magnetic disk drive 180 for reading from or writing to a removable magnetic disk 190, and an optical disk drive 191 for reading from or writing to a removable optical disk 199, such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. These drives and their associated computer-readable media provide nonvolatile storage of computer-readable instructions, data structures, program modules, and other data for the personal computer 100. It will be appreciated by those skilled in the art that other types of computer-readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 199, ROM 140, or RAM 150, including an operating system 195, one or more application programs 196, other program modules 197, and program data 198. A user can enter commands and information into the computer 100 through input devices, such as a keyboard 101 and pointing device 102 (such as a mouse). Other input devices (not shown) may include a microphone, joystick, game pad, satellite dish, scanner, or the like. These and other input devices often are connected to the processing unit 110 through a serial port interface 106 that is coupled to the system bus 130, but they also may be connected by other interfaces, such as a parallel port, game port, or a universal serial bus (USB), and the like. Further still, these devices may be coupled directly to the system bus 130 via an appropriate interface (not shown).

A monitor 107 or other type of display device also may be connected to the system bus 130 via an interface, such as a video adapter 108. In addition to the monitor 107, personal computers typically include other peripheral output devices (not shown), such as speakers and printers. In some example environments, a stylus digitizer 165 and accompanying stylus 166 are provided in order to digitally capture freehand input. Although a connection between the digitizer 165 and the serial port interface 106 is shown in FIG. 1, in practice, the digitizer 165 may be directly coupled to the processing unit 110, or it may be coupled to the processing unit 110 in any suitable manner, such as via a parallel port or another interface and the system bus 130 as is known in the art. Furthermore, although the digitizer 165 is shown apart from the monitor 107 in FIG. 1, the usable input area of the digitizer 165 may be co-extensive with the display area of the monitor 107. Further still, the digitizer 165 may be integrated in the monitor 107, or it may exist as a separate device overlaying or otherwise appended to the monitor 107.

The computer 100 can operate in a networked environment using logical connections to one or more remote computers, such as a remote computer 109. The remote computer 109 can be a server, a router, a network PC, a peer device or other common network node, and it typically includes many or all of the elements described above relative to the computer 100, although for simplicity, only a memory storage device 111 has been illustrated in FIG. 1. The logical connections depicted in FIG. 1 include a local area network (LAN) 112 and a wide area network (WAN) 1 13. Such networking environments are commonplace in offices, enterprise-wide computer networks, intranets, and the Internet, using both wired and wireless connections.

When used in a LAN networking environment, the computer 100 is connected to the local area network 112 through a network interface or adapter 114. When used in a WAN networking environment, the computer 100 typically includes a modem 115 or other means for establishing a communications link over the wide area network 113, such as the Internet. The modem 115, which may be internal or external to the computer 100, may be connected to the system bus 130 via the serial port interface 106. In a networked environment, program modules depicted relative to the personal computer 100, or portions thereof, may be stored in the remote memory storage device.

It will be appreciated that the network connections shown are examples, and other techniques for establishing a communications link between computers can be used. The existence of any of various well-known protocols such as TCP/IP, Ethernet, FTP, HTTP, UDP, and the like is presumed, and the computer 100 can be operated in a user-server configuration to permit a user to retrieve web pages from a web-based server. Any of various conventional web browsers can be used to display and manipulate data on web pages.

Although the FIG. 1 environment shows one example environment, it will be understood that other computing environments also may be used. For example, an environment may be used having fewer than all of the various aspects shown in FIG. 1 and described above, and these aspects may appear in various combinations and subcombinations that will be apparent to one of ordinary skill. Additional elements, devices or subsystems also may be included in or coupled to the computer 100.

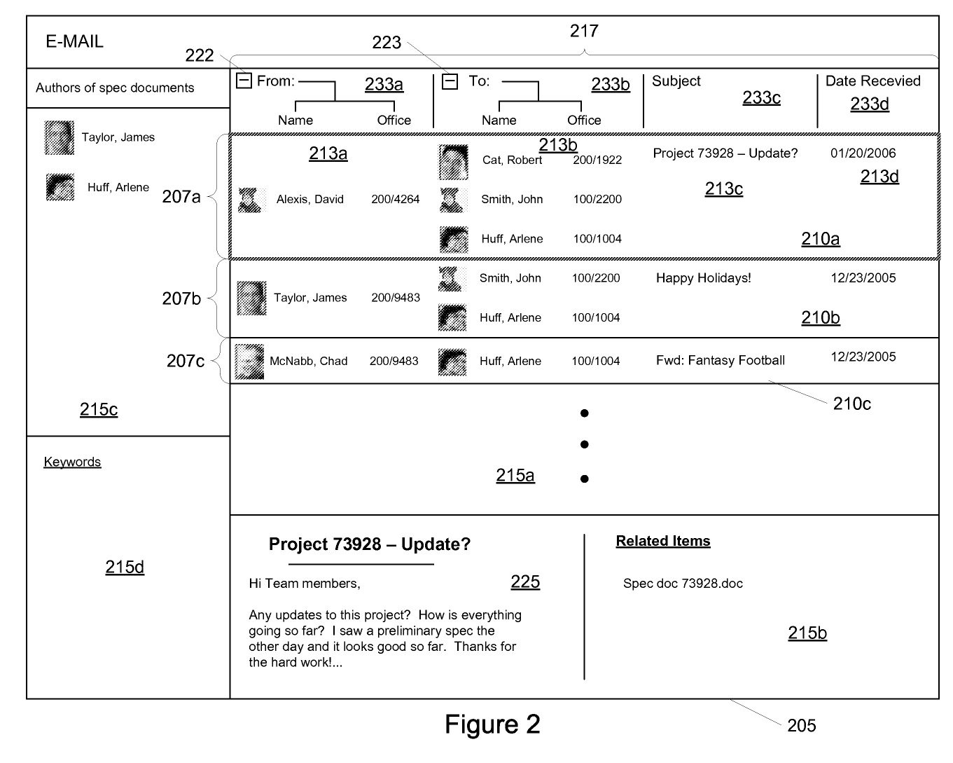

FIG. 2 illustrates a display displaying various interfaces including e-mail application interface 205 according to aspects described herein. E-mail application interface 205 may be configured to display a variety of information relating to the e-mail application and data associated therewith (e.g., e-mail messages 210). Application window 205 may include multiple sections 215, each of which may be dedicated to displaying different and/or varying types of information. For example, section 215a may be used to display a list of e-mail messages 210 while section 215b may display details of a selected e-mail message. Such details may include a preview of the message, e.g., preview 225, information about the sender and/or recipients, identified documents and data relating to the e-mail and the like. Interface 205 may include additional or alternative sections (not shown) providing other pertinent information based on a user or system's particular needs and preferences. In one example, a third section of interface 205 may display an e-mail history including previous replies and messages in the e-mail chain of a currently selected message.

Section 215a of e-mail application interface 205 may display e-mail messages in a variety of ways. For example, in FIG. 2, e-mail messages 210 may be listed vertically in individual rows 207. Messages 210 may be listed in an order determined based on one or more message properties. Section 215a may further display a variety of properties associated with each of messages 210. These message properties may include a sender, one or more recipients, a subject and a date of receipt. Messages 210 may be displayed in section 215a such that each property is displayed in a separate column of section 215a. Thus, in one example, sender information for each of messages 210 may be displayed in first column 213a, followed by recipient information in second column 213b, followed by a message subject in third column 213c and date in fourth column 213d. If a property includes more than one item of information (e.g., more than one recipient), each item may be displayed on a different line within the column corresponding to that property. The names or other identification information of each property represented by each of columns 213 may be displayed in title bar 217. Additionally, selecting a property of title bar 217 may cause messages 210 to be reorganized based on the selected property. Thus, messages 210 may be sorted according to date received by selecting the receipt date property in title bar 217. Likewise, messages 210 may be organized according to recipient by selecting the recipient property in title bar 217. The property under which messages 210 are currently organized may be highlighted or otherwise differentiated in title bar 217.

According to one or more aspects, one or more message properties of an e-mail message such as message 210a, may relate to a system entity. A system entity or entity, as used herein, generally refers to a predefined type of data for which relationships may be established with other entities. Entities may be defined for e-mail messages, people/contacts, images, purchase orders, work orders, opportunities and the like. As such, a message entity (i.e., an e-mail message such as message 210a) may be related to a predefined contact entity corresponding to the sender of e-mail message 210a. A contact entity may include one or more properties such as an employment title, phone number, office address and residence. Accordingly, the property data associated with the sender of message 210a may be displayed in the region defined by row 207a and column 213a (corresponding to message 210a and the sender message property, respectively). In particular, the contact entity property data may be displayed simultaneously with the message entity property data. Similarly, contact information corresponding to a recipient of message 210a may be displayed in the region defined by row 207a and column 213b. If multiple contacts/recipients are specified in message 210a, property data associated with each of the contacts may be displayed inline with the corresponding contact. Further, property data derived from a contact entity rather than a message entity may be differentiated in a variety of ways including the use of different fonts and colors.

Additionally or alternatively, in title bar 217, each of regions 233 corresponding to each of property columns 213 may include a toggle control, e.g., controls 222 and 223, for configuring how much information is displayed for each entity. Thus, a user may manipulate control 222, for example, to specify how much property data (e.g., office number, address, title) he or she wishes to see for each sender contact entity. Similarly, a user may manipulate control 223 to hide or show an office property for each recipient contact entity. The size of each of regions 233 may also be configurable. In one example, region 233a may be reduced in width and region 233c expanded in width to allow more of the data associated with region 233c to be displayed.

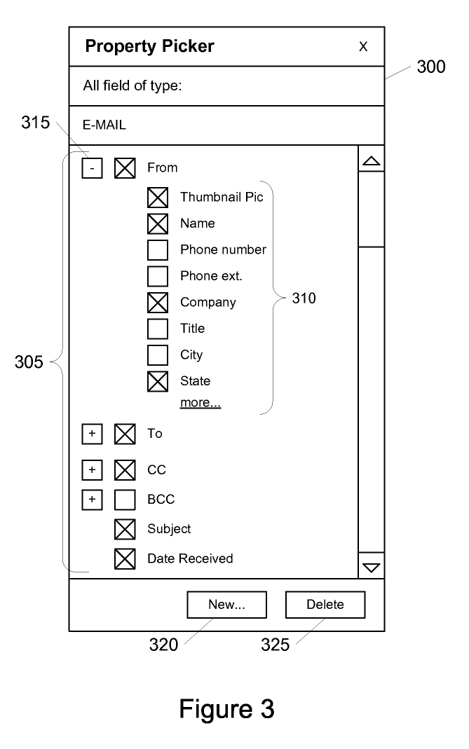

FIG. 3 illustrates a property picker interface that allows a user to choose which types of property data to display for an entity type. In interface 300, multiple properties 305 of an e-mail message are displayed for reference. Properties 305 include from (i.e., sender), to (i.e., recipient(s)), carbon copy (CC) (i.e., copied recipient(s)), blind carbon copy (BCC) (i.e., blind copied recipient(s)), subject and date received. A user may choose to activate or deactivate the display of each of properties 305. In addition, for each of the related entity types that may be associated with message properties 305, a menu of related entity properties 310 may be displayed for selection. For example, a contact entity associated with a sender or from message property, as described above, may include contact properties 310 such as a picture, a name, a phone number, a phone extension, a company name, a title, a city of residence and a state of residence. Thus, a user may select the properties that he or she wants to have displayed in a messaging interface such as interface 205 of FIG. 2. Selections may be made of properties 305 and 310 using a variety of controls such as check boxes, radio buttons and the like. In addition, properties 305 and 310 may be hidden or exposed using an expansion control like control 315.

In one or more arrangements, interface 300 may further allow a user to add new properties or delete available properties using new option 320 and delete option 325, respectively. In one example, a user may select the thumbnail picture property from properties 310 and delete the property from the list using option 325. Pressing option 320, on the other hand, may create a new entry in properties 3 10. A user may then modify the new entry according to the desired new property. For example, upon pressing new option 320, a dialog may prompt the user to specify a type of information to be entered. Various types of information may include numbers, text, alphanumeric, symbols, currency, date and the like. Thus, if a user attempts to enter a birthday property for a contact entity, he or she may specify that the new birthday property includes date type information.

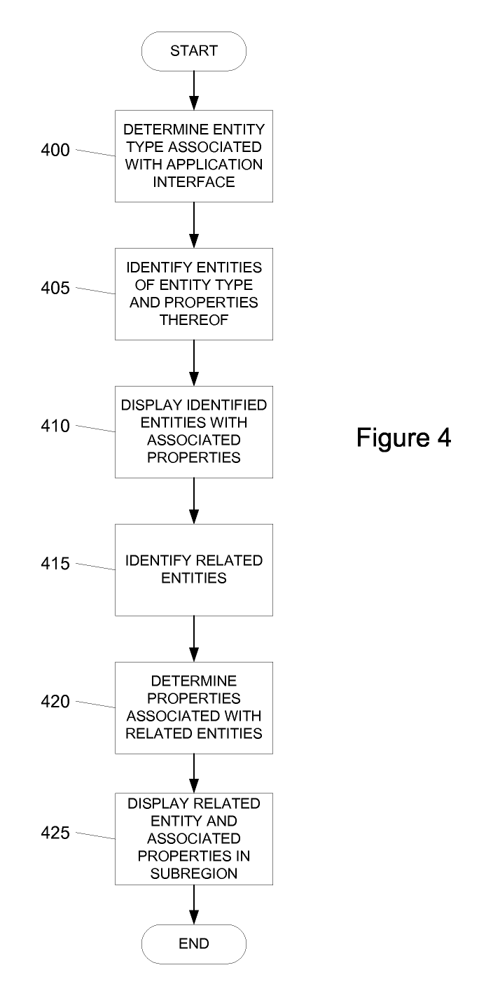

FIG. 4 is a flowchart illustrating a method for displaying an application interface according to aspects described herein. In step 400, a system may determine an entity type associated with the application interface. For example, an application interface corresponding to an e-mail program may be associated with an e-mail or message entity type. In another example, a photo application interface may be associated with an image entity type. Entity types and associations therewith may be defined by default or may be manually defined by a user. In step 405, one or more entities of the determined entity type as well as properties thereof may be identified. The entities may be determined from a storage facility such as an application specific database. Alternatively or additionally, entities may be derived from a system wide database. In the example of an e-mail application interface, e-mails (i.e., message entities) may be identified from an e-mail database. Once identified, the entities may be displayed along with their associated properties in the application interface in step 410. Thus, if an e-mail includes properties such as sender information, recipient information, a subject and a date received, this information may be displayed as part of the message entity. The entities may be displayed in a variety of configurations such as the vertical orientation described in FIG. 2. Particularly, each entity may be displayed as an independent row of the interface. Each property of the entity may further be displayed in independent columns.

In step 415, the system may identify one or more related entities associated with each entity displayed. Related entities may be identified based on the properties of the displayed entities. For example, a message entity may include a sender property that relates to a particular contact entity. Thus, the contact entity may be related to the message entity by virtue of the sender property. Similarly, a contact entity corresponding to a person depicted in a photograph may be considered a related entity to an image or photo entity. Upon identifying the one or more related entities, one or more properties of the related entities may be determined in step 420. A contact entity, for example, may be associated with properties such as name, phone number, office address, company, title and the like. These properties may be specified in the entity type definition. In step 425, each related entity and/or its associated properties may be displayed in a subregion of the parent entity's display region. For example, a contact entity and its associated properties may be displayed in a subregion defined by a row corresponding to the message entity to which the contact entity is related and the column corresponding to the sender property of the message entity. In one or more configurations, only those properties previously selected in a property picker interface (e.g., interface 300 of FIG. 3) might be displayed.

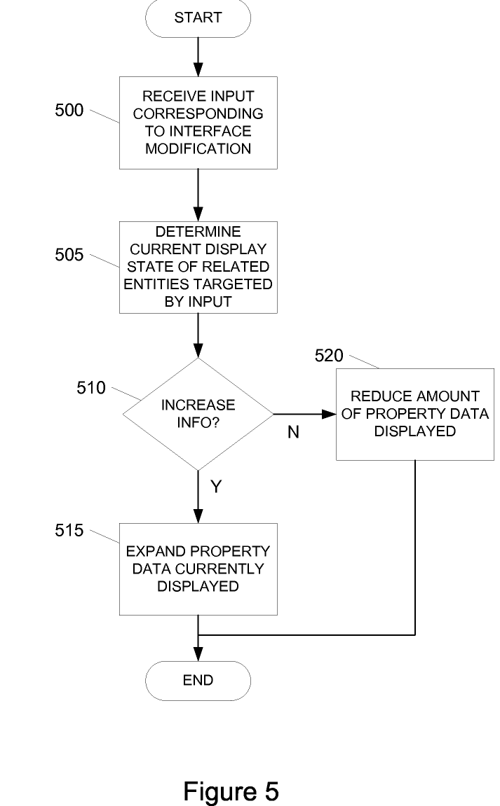

FIG. 5 illustrates a method for manipulating an application interface. In step 500, an application may receive user input corresponding to a command for modifying the amount of information displayed in the application interface. In step 505, the application may determine a current display state of one or more related entities targeted by the modification command. The current display state may include information like the number of properties currently being displayed for the related entities versus how many are available. Based on the current display state information, the application may determine whether the modification command corresponds to a request to display more related entity properties or less related entity properties in step 510. For example, in response to determining that a minimum amount of entity properties are being displayed, an application may determine that the modification command corresponds to a request to display more property data. Alternatively, if an application detects that a maximum amount of entity properties are currently displayed, the application may determine that the command corresponds to a request to reduce the amount of property data shown. Other considerations that may be taken into account when determining whether to display more or less information may include completeness of related entity properties and/or an amount of screen space occupied.

If, in step 510, it is determined more property data is requested, the application may, in step 515, expand the amount of property data displayed for each corresponding related entity to a predefined amount, e.g., all of the available property data. If, on the other hand, an application determines that the modification command corresponds to a request to reduce the amount of displayed property data, the application may decrease the amount of displayed property data in step 520. In one or more configurations, the amount of displayed property data may be reduced to a predefined number (e.g., 1) of properties for each related entity. The properties to be displayed may be selected based on importance or pertinence as specified by either the user or a system default or both. The properties, in one or more examples, may also be ranked in order of pertinence or importance automatically or manually by a user.

Alternatively or additionally, controls may be provided for allowing a user to independently manipulate each property of a related entity. That is, a user may be provided with individual control over whether a related entity property is to be hidden or displayed. Thus, a user may be able to hide a contact entity's name while displaying a thumbnail picture corresponding to the contact. A variety of other controls may be implemented to manipulate the appearance and amount of information displayed in an application interface.

While many aspects have been described herein with respect to messaging applications, one of ordinary skill in the art will appreciate that the same may be applied with other types of applications and entities. For example, the visualization systems and methods discussed may be used for displaying, browsing and accessing photos or images. The photos or images may be defined as an entity type and be related to contact entities corresponding to the individuals depicted in the photos. The contact entities may then be displayed in association with the image or photo entity to which they correspond. This allows a user to not only view the photo information, but to also simultaneously view information about entities associated with the photo (e.g., the people depicted therein). As discussed, various controls may be provided to customize and manipulate the interface to show a desired amount of entity and related entity property data. In another example, similar visualization features may be added for browsing and accessing electronic documents.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Numerous other embodiments, modifications and variations within the scope and spirit of the appended claims will occur to persons of ordinary skill in the art from a review of this disclosure.

We claim:

1. A computer readable medium storing computer executable instructions that, when executed, cause a processor to perform a method comprising:
identifying at least one related entity having a relationship with a first entity based on one or more first entity properties associated with the first entity;
displaying the first entity in a first region of a user interface, the first region including one or more subregions corresponding to the one or more first entity properties;
determining one or more second entity properties corresponding to a first related entity of the identified at least one related entity; and
displaying the first related entity in a first subregion of the one or more subregions, wherein the first subregion is configurable to display the determined one or more second entity properties corresponding to the first related entity.

2. The computer readable medium of claim 1, wherein the first subregion is further configurable within the first region to hide one or more of the one or more second entity properties.

3. The computer readable medium of claim 1, wherein the first entity corresponds to an e-mail message, the first related entity corresponds to a sender of the e-mail message, and the one or more second entity properties include at least one of: a name of the sender, a picture corresponding to the sender, a phone number of the sender, and an office location of the sender.

4. The computer readable medium of claim 1, further comprising instructions for displaying a second related entity in the first subregion.

5. The computer readable medium of claim 1, wherein the user interface further includes a display control for controlling a number of the one or more second entity properties that are displayed in the first subregion.

6. The computer readable medium of claim 1, further including instructions for:
determining one or more third entity properties corresponding to a second related entity of the at least one related entity; and
displaying the second related entity in a second subregion of the one or more subregions, wherein the second subregion is configurable to display the determined one or more third entity properties corresponding to the second related entity.

7. The computer readable medium of claim 6, wherein the first entity corresponds to an e-mail message and the second related entity corresponds to a recipient of the e-mail message.

8. The computer readable medium of claim 1, wherein the one or more first entity properties includes at least one of: a sender, a recipient, a subject, and a date received.

9. A method for configuring an interface, the method comprising:
identifying a plurality of related entities having a relationship with a first entity based on one or more first entity properties associated with the first entity;
displaying the first entity in a first region of the interface, the first region including one or more subregions corresponding to the one or more first entity properties;
determining one or more second entity properties corresponding to a first related entity of the plurality of related entities;
determining one or more third entity properties corresponding to a second related entity of the plurality of related entities; and
displaying the plurality of related entities in a first subregion of the one or more subregions.

10. The method of claim 9, wherein the first entity corresponds to an e-mail message, the first related entity corresponds to a first recipient of the e-mail message and the second related entity corresponds to a second recipient of the e-mail message.

11. The method of claim 10, wherein the one or more second entity properties include at least one of: a name of the first recipient, a picture corresponding to the first recipient, a phone number of the first recipient, and an office location of the first recipient.

12. The method of claim 9, wherein the user interface further includes a display control for controlling a number of the one or more second entity properties displayed in the first subregion.

13. The method of claim 9, further including the steps of:
determining one or more fourth entity properties corresponding to a third related entity of the plurality of related entities; and
displaying the third related entity in a second subregion of the one or more subregions, wherein the second subregion is configurable to control a number of the determined one or more fourth entity properties corresponding to the third related entity that are displayed in the second subregion.

14. The method of claim 9, wherein the first entity is an image and the plurality of related entities correspond to contacts depicted in the image.

15. A system comprising:
a display;
a processor; and
memory storing computer executable instructions, that when executed, cause the processor to perform a method comprising:
identifying at least one related entity having a relationship with a first entity based on one or more first entity properties associated with the first entity;
displaying, on the display, the first entity in a first region of a user interface, the first region including one or more subregions corresponding to the one or more first entity properties;
determining one or more second entity properties corresponding to a first related entity of the identified at least one related entity; and
displaying, on the display, the first related entity in a first subregion of the one or more subregions, wherein the first subregion is configurable to display the determined one or more second entity properties corresponding to the first related entity.

16. The system of claim 15, wherein the first subregion is further configurable within the first region to hide one or more of the one or more second entity properties.

17. The system of claim 15, wherein the first entity corresponds to an image, the first related entity corresponds to a contact depicted in the image, and the one or more second entity properties include at least one of: a name of the contact, a thumbnail picture corresponding to the contact, a phone number of the contact, and an office location of the contact.

18. The system of claim 15, further comprising instructions for displaying a second related entity in the first subregion.

19. The system of claim 15, wherein the user interface further includes a display control for controlling a number of the one or more second entity properties displayed in the first subregion.

20. The system of claim 15, wherein the one or more second entity properties are ranked according to pertinence.
